(19) United States
(12) Patent Application Publication
(10) Pub. No.: US 2019/0316009 A1
(43) Pub. Date: Oct. 17, 2019

(54) ADHESIVE COMPOSITION, CURED PRODUCT, AND PRECISION PART

(71) Applicant: NAMICS CORPORATION, Niigata (JP)

(72) Inventor: Katsunori ARAI, Niigata (JP)

(21) Appl. No.: 16/309,534

(22) PCT Filed: Jun. 27, 2017
(86) PCT No.: PCT/JP2017/023505

§ 371 Date: Dec. 13, 2018

(30) Foreign Application Priority Data
Jul. 4, 2016 (JP) 2016-132279

(51) Int. Cl. C09J 11/06; C08K 5/14; C08K 5/32; C08G 73/06; C09J 11/04; C09J 4/00; C08K 3/08; C08F 20/18

(52) U.S. Cl. CPC C09J 11/06; C08K 5/14; C08K 5/32; C08G 73/0611; C08K 2003/0831; C09J 4/00; C08K 3/08; C08F 20/18; C08K 2003/0806; C09J 11/04

(57) ABSTRACT

To provide adhesive compositions that have a long pot life which, when used in a two-stage process involving partial curing and complete curing, can be cured completely at a temperature lower than that for partial curing. An adhesive composition including: a curable resin that is radically polymerizable; an organic peroxide having a one-minute half-life temperature of less than 100° C.; and a radical polymerization inhibitor, wherein a rate of viscosity increase of the adhesive composition at 25° C. and after 48 hours is 1.5 or less, partial curing of the adhesive composition is possible by heating at 100° C. to 180° C. for 1 to 5 second(s), and complete curing of the adhesive composition is possible by heating at 70° C. to 100° C. after the partial curing.

### TECHNICAL FIELD

The present invention relates to adhesive composition, cured product obtained by curing one of the adhesive compositions, and precision part with one of the cured products.

### BACKGROUND ART

Camera modules used for mobile devices such as smartphones require the provision of an enhanced photographing function as well as compaction. Thus, there is a desire to reduce the overall size of entire camera modules while maintaining the size (or increasing the size) of optical components such as a CCD, a CMOS, a set of lenses or other components included in camera modules. For this reason, a portion where the assembly with the application of adhesive requires high positional accuracy.

To ensure high positional accuracy, it is necessary to reduce unwanted misalignment after the application of adhesives. One technique to reduce such misalignment is to perform bonding via a two-stage curing process involving partial curing and complete curing. For example, after an adhesive is applied to an FPC board, the adhesive is subjected to partial curing by heating for a short period of time using a heater at the same time when a stiffener is placed thereon, thereby temporarily fixing the position of the stiffener on the FPC board. Subsequently, complete curing is performed using, for example, an oven over a long period of time to assemble the stiffener onto the FPC board.

Furthermore, another example of the two-stage method uses an adhesive obtained by combining a UV-curable, radically polymerizable resin and a thermosetting resin. In this case, the radically polymerizable resin is cured first for temporal fixture via UV irradiation (partial curing), and heat is subsequently applied to cure the thermosetting resin (complete curing). It is preferable to use such a radically polymerizable resin having high reactivity to quickly perform partial curing. To prevent unintended radical polymerization (curing reaction), a polymerization inhibitor as described in JP-A-2006-045459 may be used in some cases.

However, as in JP-A-2013-082836, adhesives obtained by mixing two kinds of resins having different curing reactions, such as an epoxy resin and a radical curable resin, are cumbersome because different means (UV or heat) require to be used for partial curing and complete curing. Further, complete curing, which is performed for a long period of time, is preferably performed at a low temperature so that the heat during curing does not affect precision parts such as optical components.

Thus, it is contemplated to perform partial curing at a high temperature in a short period of time and to perform complete curing, which takes a longer period of time, at a lower temperature than partial curing. In this case, partial curing cannot be performed unless radicals are generated by applying sufficient heat at the time of partial curing. However, the amount of consumed free radical initiators increases at a high temperature. Therefore, the radical initiator necessary for subsequent complete curing at a low temperature may possibly be insufficient.

In order to prevent this situation, adding a large amount of radical initiator is plausible. However, when a large amount of radical initiator is added, there is a possibility that unexpected radical polymerization proceeds (for example, initiation of curing reaction at room temperature). Therefore, the pot life of the adhesive composition may be shortened.

An object of the present invention is to provide compositions used as adhesives, i.e., adhesive compositions that have a long pot life which, when used in a two-stage process involving partial curing and complete curing, can be cured completely at a temperature lower than that for partial curing, and cured products thereof, and precision parts with one of the cured products.

### SUMMARY OF THE INVENTION

The main invention to achieve the aforementioned object is an adhesive composition including a curable resin that is radically polymerizable; an organic peroxide having a one-minute half-life temperature of less than 100° C.; and a radical polymerization inhibitor, wherein a rate of viscosity increase of the adhesive composition at 25° C. and after 48 hours is 1.5 or less, a partial curing of the adhesive composition is possible by heating at 100° C. to 180° C. for 1 to 5 second(s), and a complete curing of the adhesive composition is possible by heating at 70° C. to 100° C. after the partial curing. Other features of the present invention are disclosed using the description of the present specification.

### Effect of the Invention

The adhesive compositions of the present invention have a long pot life and, when used in a two-stage process involving partial curing and complete curing, complete curing of the adhesive compositions is possible at a temperature lower than that for partial curing.

### DETAILED DESCRIPTION OF THE INVENTION

### Disclosure of the Invention

According to the description of the present specification, at least the following are disclosed in addition to the aforementioned main invention.

That is, the adhesive composition in which a heating condition for the partial curing is 120° C. and 3 seconds or less and a heating condition for the complete curing is 80° C. is disclosed. Such adhesive composition has a long pot life, and complete curing thereof is possible at a temperature (80° C.) lower than that (120° C.) for partial curing.

Furthermore, the adhesive composition in which the radical polymerization inhibitor is a nitrosamine compound is disclosed. By using a nitrosamine compound as the radical polymerization inhibitor, it is possible to reduce unintended radical polymerization and prolong the pot life of the adhesive composition.

Moreover, the adhesive composition in which the organic peroxide is any one of peroxybis(formic acid propyl) ester, peroxybis(formic acid isopropyl) ester, bis(4-tert-butylcyclohexyl) peroxydicarbonate, 1,1,3,3-tetramethylbutyl peroxyneodecanoate. peroxybis(formic acid sec-butyl) ester or a combination thereof is disclosed. Since these organic peroxides have a low half-life temperature, they can be used for curing reactions at lower temperatures.

Furthermore, the adhesive composition in which the curable resin comprises 40% to 60% by weight of a curable resin contributing to radical polymerization and having a functional group equivalent weight of 600 to 900 is disclosed. By using such curable resin, it is possible to increase the bond strength of the adhesive compositions and prolong the pot life thereof. If the content of a resin contributing to radical polymerization and having a functional group equivalent weight of less than 600 is too high, cure shrinkage increases and interfacial delamination tends to occur. On the other hand, if the content of a resin having a functional group equivalent weight of more than 900 is too high, the crosslinking density decreases and the strength of cured products tends to be low.

In addition, an adhesive composition including a curable resin comprising 40% to 60% by weight of a curable resin contributing to radical polymerization and having a functional group equivalent weight of 600 to 900; any one of peroxybis(formic acid propyl) ester, peroxybis(formic acid isopropyl) ester, bis(4-tert-butylcyclohexyl) peroxydicarbonate, 1,1,3,3-tetramethylbutyl peroxyncodecanoate, and peroxybis(formic acid sec-butyl) ester; and a nitrosamine compound is disclosed. Such adhesive composition has a long pot life and, when used in a two-stage process involving partial curing and complete curing, complete curing of adhesive compositions is possible at a temperature lower than that for partial curing.

Furthermore, the adhesive composition further including a precious metal filler is disclosed. Such adhesive composition has conductivity.

Moreover, a cured product obtained by curing one of the aforementioned adhesive compositions is disclosed. The adhesive compositions from which such cured product is obtained have a long pot life. Accordingly, the cured product can be used for a variety of objects.

Furthermore, a precision part with the aforementioned cured product is disclosed. The adhesive compositions from which the cured product is obtained have a long pot life. Accordingly, the cured product can be used for a variety of precision parts.

### Embodiments

### Contents of Adhesive Compositions

An adhesive composition according to this embodiment contains at least a curable resin that is radically polymerizable, a radical polymerization initiator, and a radical polymerization inhibitor.

In this embodiment, the term “partial curing” refers to partially curing adhesive compositions by applying heat to the compositions for a short period of time. By way of example, partial curing refers to a state wherein an object is loosely secured to a substrate by placing the object on the substrate to which an adhesive composition has been applied and applying heat for a short period of time. The bond strength at partial curing is, for example, 0.1 kgf/mm² to 1 kgf/mm². The term “complete curing” refers to curing adhesive compositions completely by applying heat to the compositions for a long period of time. By way of example, complete curing refers to a state wherein an object is completely secured to a substrate by applying heat to the loosely secured object and substrate, for example, in an oven for a long period of time (longer than that for partial curing). The bond strength at complete curing is, for example, 0.5 kgf/mm² to 3 kgf/mm². The term “pot life” refers to the time for an adhesive composition to remain workable after the adhesive composition is prepared. The term “rate of viscosity increase” refers to a rate of change in viscosity of an adhesive composition after an elapse of a predetermined period of time relative to that of the adhesive composition immediately after being prepared.

### Curable Resins that are Radically Polymerizable

Curable resins that are radically polymerizable impart adhesiveness and curability to adhesive compositions, and they are defined as resins that are cured as radical polymerization proceeds. Because curable resins that are radically polymerizable polymerize quickly, curing such as partial curing can be performed quickly. For such curable resins, any resins can be used as long as they are radically polymerizable. Among commercially available examples, BMI-1500 (a bismaleimide resin manufactured by Designer molecules Inc.), Light Acrylate PO-A (an acrylic resin manufactured by Kyoeisha Chemical Co., Ltd.), and HEAA (an acrylic resin manufactured by KJ Chemical Co., Ltd.) can be used. From the viewpoint of stability (heat resistance, moisture resistance) and flexibility of the cured products obtained by curing the adhesive compositions, it is preferable to include an acrylic resin or a bismaleimide resin.

It is preferable that the adhesive composition contains 40% to 60% by weight of curable resin contributing to radical polymerization and haying a functional group equivalent weight of 600 to 900. Resins with a greater functional group equivalent weight contain fewer functional groups in their molecules, which reduces their radical polymerization reactivities (radical polymerization proceeds at a lower rate; in other words, curing reaction of the resin becomes unlikely to proceed well). Accordingly, it is possible to reduce or eliminate an increase in rate of viscosity increase due to unintended radical polymerization during the storage of the adhesive compositions (i.e., the pot life can be extended). If the content of such curable resin is less than 40% by weight, the pot life is affected. If the content of such curable resin exceeds 60% by weight, the resulting adhesive composition will have poor curability.

Furthermore, it is preferable that the curable resin that is radically polymerizable is in a liquid state. The use of a liquid curable resin eliminates the necessity of any solvent; thus, the occurrence of voids when using an adhesive composition can be prevented. The content of the solvent is preferably less than 3% by weight, more preferably less than 1% by weight in the adhesive composition, but most preferably the adhesive composition is solvent-free. Only one curable resin (for example, only an acrylic resin) may be used, or two or more kinds of curable resins (for example, an acrylic resin and a bismaleimide resin) may be used in combination.

### Radical Polymerization Initiators

Radical polymerization initiators generate radicals as active species as a result of bond cleavage at a predetermined temperature. These radicals as active species initiate a radical polymerization reaction of the aforementioned curable resin(s). The radical polymerization initiator in this embodiment is an organic peroxide having a one-minute half-life temperature of lower than 100° C. Specifically, the temperature is 87C. to 99° C. Because these organic peroxides are cleaved at a temperature lower than 100° C., they can be used for curing at low temperatures. Examples of these organic peroxides include peroxybis(formic acid propyl) ester, peroxybis(formic acid isopropyl) ester; bis(4-test-butylcyclohexyl) peroxydicarbonate, 1,1,3,3-tetramethylbutyl peroxyneodecanoate, and peroxybis(formic acid sec-butyl) ester. Among commercially available products, by way of example, PEROYL TCP (having a one-minute half-life temperature of about 92° C.; manufactured by NOF CORPORATION “PEROYL” is a registered trademark) can be used.

### Radical Polymerization Inhibitors

Radical polymerization inhibitors suppress radical polymerization and prolong the pot life of adhesive compositions. The radical polymerization inhibitor in this embodiment is a nitrosamine compound. As described above, in this embodiment, a radical polymerization initiator which cleaves at low temperatures is used. Therefore, an unintended radical polymerization reaction may initiate even at room temperature. Such unintended radical polymerization reaction can be prevented by adding a radical polymerization inhibitor to the adhesive composition. Among commercially available products, by way of example, Q-1301 (manufactured by Wako Pure Chemical Industries, Ltd.) which is an aluminum salt of nitrosamine can be used. By using nitrosamine, an unintentional radical polymerization reaction can be prevented at room temperature (ordinary temperature) while the curing reaction is not inhibited during the complete curing at a temperature lower than 100° C.

### Other Additives

In addition to the above, the adhesive composition according to this embodiment may contain a silane coupling agent or a filler. By using a precious metal filler (e.g., gold filler or silver filler), the conductivity of the adhesive composition can be increased.

### Method of Manufacturing Adhesive Compositions

The adhesive composition according to this embodiment is obtained by mixing at least a curable resin that is radically polymerizable, a radical polymerization initiator, and a radical polymerization inhibitor. Any method can be used for producing the adhesive composition as long as the materials are sufficiently kneaded. The tatio of the components is, for example, as follows: a ratio of the curable resin that is radically polymerizable to the radical polymerization initiator (organic peroxide) to the radical polymerization inhibitor (nitrosamine compound) is 100 to 8-15 to 0.08-0.15. In the adhesive composition according to this embodiment, the ratio of the radical polymerization initiator and the radical polymerization inhibitor to the curable resin that is radically polymerizable is higher than that used in the past. By adding such a larger amount of radical polymerization initiator, even when heating is sufficiently performed at partial curing to generate radicals as the active species, it is possible to leave a sufficient amount of radical initiator used for complete curing. In addition, by adding a large amount of radical polymerization inhibitor, it is possible to prevent an unintended radical polymerization reaction due to a large amount of radical polymerization initiator; thus, the pot life of the adhesive composition can be prolonged. Specifically, the adhesive composition produced in this manner has a rate of viscosity increase of 1.5 or less at 25° C. and after 48 hours. A long pot life can thus be ensured. Such a long pot life makes it possible to mass produce and preserve the adhesive composition. Furthermore, it is unnecessary to store and transport adhesive compositions as a two-part liquid system to retard their curing. In other words, the adhesive composition according to this embodiment can be produced as a one-part system, which facilitates handing.

### Cured Products

The adhesive composition according to this embodiment can be cured by a two-stage reaction involving partial curing at a high temperature, partial curing, and a subsequent complete curing at a lower temperature to obtain a cured product. The specific methods of partial curing and complete curing are not particularly limited as long as the adhesive composition can be cured. It is possible to use a desired curing method depending on where an adhesive composition is used. Here, a heating condition for the partial curing of the adhesive composition according to this embodiment is heating at 100° C. to 180° C. for 1 to 5 second(s). A heating condition for the complete curing of the adhesive composition according to this embodiment is heating at 70° C. to 100° C. More preferably, the heating condition for the partial curing is 100° C. to 140° C. and 3 seconds or less, and the heating condition for the complete curing is 70° C. to 90° C.

As described above, the adhesive composition according to this embodiment can produce a cured product via a two-stage radical reaction (partial curing at high temperature and then complete curing at low temperature) using the same radical initiator for the same curable resin. Therefore, it is unnecessary to use different curing methods (UV and heat) in a two-stage reaction as in JP-A-2013-082836.

### Precision Parts

Precision parts include electronic components used for optical components (such as camera modules) or semiconductor devices, semiconductor circuits (or modules or electronic devices incorporating them), or the like. These components require high positional accuracy when being assembled. The use of the adhesive composition according to this embodiment makes it possible to obtain a precision part satisfying the above requirement. Furthermore, the adhesive composition according to this embodiment can be subjected to complete caring that takes a long period of time at a low temperature, it is possible to reduce the influence of the heat on the precision parts.

### EXAMPLES

For the adhesive compositions obtained in the following Examples 1 to 7 and Comparative Examples 1 to 6, their rate of viscosity increase and curability were measured.

As the curable resin that is radically polymerizable, two of the following compounds were used in combination:
“BMI-1500” (a liquid bismaleimide resin, manufactured by Designer molecules Inc.)
“BMI-3000” (a solid bismaleimide resin, manufactured by Designer molecules Inc.)
“Light Acrylate PO-A” (a low-molecular weight resin that is radically polymerizable, manufactured by Kyoeisha Chemical Co., Ltd.)

As the radical polymerization initiator, one of the following was used.
“Peroyl TCP” (an organic peroxide with a one minute half-life temperature of 92.1° C., manufactured by NOF CORPORATION)
“PEROCTA O” (an organic peroxide with a one minute half-life temperature of 124.3° C., manufactured by NOF CORPORATION; “PEROCTA” is a registered trademark)

As the radical polymerization inhibitor, one of the following was used.
“Q1301” (an aluminum salt of nitrosamine manufactured by Wako Pure Chemical Industries, Ltd.)
“Hydroquinone” (manufactured by Wako Pure Chemical Industries, Ltd.)
“2,2,6,6-tetramethyl-1-piperidinyloxy, radical” (2,2,6,6-tetramethylpiperidine 1-oxyl (TEMPO) manufactured by Wako Pure Chemical Industries, Ltd.)

As a filler, a silver filler (scaly, with a median diameter (D50) of 8 μm and a specific surface area of 0.7 m²/g) was used.

### Example 1

7 parts by mass of “BMI-1500,” 7 parts by mass of “Light Acrylate PO-A,” 1.35 parts by mass of “Peroyl TCP,” 0.014 parts by mass of “Q-1301,” and 86 parts by mass of “silver filler” were mixed and the silver filler was dispersed homogeneously in the liquid components using a triple-roll mill to prepare an adhesive composition “a.”

### Example 2

An example in which Example 1 was followed except that the amounts of radical polymerization initiator and the radical polymerization inhibitor were reduced

7 parts by mass of “BMI-1500,” 7 parts by mass of “Light Acrylate PO-A,” 1.2 parts by mass of “Peroyl TCP” 0.012 parts by mass of “Q-1301,” and 86 parts by mass of “silver filler” were mixed and the silver filler was dispersed homogeneously in the liquid components using a triple-roll mill to prepare an adhesive composition “b.”

### Example 3

An example in which Example I was followed except that the amounts of the radical polymerization initiator and the radical polymerization inhibitor were increased

7 parts by mass of “BMI-1500,” 7 parts by mass of “Light Acrylate PO-A,” 1.5 parts by mass of “Peroyl TCP,” 0.016 parts by mass of “Q-1301,” and 86 parts by mass of “silver filler” were mixed and the silver filler was dispersed homogeneously in the liquid components using a triple-roll mill to prepare an adhesive composition “c.”

### Example 4

An example in which Example 1 was followed except that the amount of the radical polymerization initiator was reduced and that of the radical polymerization inhibitor was increased

7 parts by mass of “BMI-1500,” 7 parts by mass of “Light Acrylate PO-A,” 1.2 parts by mass of “Peroyl TCP,” 0.016 parts by mass of “Q-1301,” and 86 parts by mass of “silver filler” were mixed and the silver filler was dispersed homogeneously in the liquid components using a triple-roll mill to prepare an adhesive composition “d.”

### Example 5

An example in which Example 1 was followed except that the amount of the radical polymerization initiator was increased and that of the radical polymerization inhibitor was reduced

7 parts by mass of “BM-1500,” 7 parts by mass of “Light Acrylate PO-A,” 1.5 parts by mass of “Peroyl TCP,” 0.012 parts by mass of “Q-1301,” and 86 parts by mass of “silver filler” were mixed and the silver filler was dispersed homogeneously in the liquid components using a triple-roll mill to prepare an adhesive composition “e.”

### Example 6

An example in which Example 1 was followed except that the amount of the liquid bismaleimide resin was reduced and that of the low-molecular weight resin that is radically polymerizable was increased

5.6 parts by mass of “BMI-1500,” 8.4 parts by mass of “Light Acrylate PO-A,” 1.35 parts by mass of “Peroyl TCP,” 0.014 parts by mass of “Q-1301,” and 86 parts by mass of “silver filler” were mixed and the silver filler was dispersed homogeneously in the liquid components using a triple-roll mill to prepare an adhesive composition “T.”

### Example 7

An example in which Example 1 was followed except that the amount of the liquid bismaleimide resin was increased and that of the low-molecular weight resin that is radically polymerizable was reduced

8.4 parts by mass of “BMI-1500,” 5.6 parts by mass of “Light Acrylate PO-A,” 1.35 parts by mass of “Peroyl TCP,” 0.014 parts by mass of “Q-1301,” and 86 parts by mass of “silver filler” were mixed and the silver filler was dispersed homogeneously in the liquid components using a triple-roll mill to prepare an adhesive composition “g.”

### (Comparative Example 1) Using PEROCTA O

7 parts by mass of “BMI-1500,” 7 parts by mass of “Light Acrylate PO-A,” 1.35 parts by mass of “PEROCTA O,” 0.014 parts by mass of “Q-1301,” and 86 parts by mass of “silver filler” were mixed and the silver filler was dispersed homogeneously in the liquid components using a triple-roll mill to prepare an adhesive composition “h.”

### (Comparative Example 2) Using Hydroquinone

7 parts by mass of “BMI-1500,” 7 parts by mass of “Light Acrylate PO-A,” 1.35 parts by mass of “Peroyl TCP,” 0.014 parts by mass of “Hydroquinone,” and 86 parts by mass of “silver filler” were mixed and the silver filler was dispersed homogeneously in the liquid components using a triple-roll mill to prepare an adhesive composition “i.”

### (Comparative Example 3) Using 2,2,6,6-tetramethyl-1-piperidinyloxy, Radical (TEMPO)

7 parts by mass of “BMI-1500,” 7 parts by mass of “Light Acrylate PO-A,” 1.35 parts by mass of “Peroyl TCP,” 0.014 parts by mass of “TEMPO,” and 86 parts by mass of “silver filler” were mixed and the silver filler was dispersed homogeneously in the liquid components using a triple-roll mill to prepare an adhesive composition “i.”

### (Comparative Example 4) An Example in which Examples were Followed except that the Amount of Peroyl TCP was Reduced

7 parts by mass of “BMI-1500,” 7 parts by mass of “Light Acrylate PO-A,” 0.9 parts by mass of “Peroyl TCP,” 0.014 parts by mass of “Q-1301,” and 86 parts by mass of “silver filler” were mixed and the silver filler was dispersed homogeneously in the liquid components using a triple-roll mill to prepare an adhesive composition “k.”

### (Comparative Example 5) An Example in which Examples were Followed except that the Amount of Q-1301 was Increased

7 parts by mass of “BMI-1500,” 7 parts by mass of “Light Acrylate PO-A,” 1.35 parts by mass of “Peroyl TCP,” 0.02 parts by mass of “Q-1301,” and 86 parts by mass of “silver filler” were mixed and the silver filler was dispersed homogeneously in the liquid components using a triple-roll mill to prepare an adhesive composition “1.”

### (Comparative Example 6) Using the Solid Curable Resin

28 parts by mass of “BMI-3000,” (a 25% solution), 7 parts by mass of “Light Acrylate PO-A,” 1.35 parts by mass of “Peroyl TCP,” 0.014 parts by mass of “Q-1301,” and 86 parts by mass of “silver filler” were mixed and the silver tiller was dispersed homogeneously in the liquid component using a triple-roll mill to prepare an adhesive composition “m.”

### Calculation of Rate of Viscosity Increase

Viscosities of the adhesive compositions immediately after being prepared and after an elapse of 48 hours at room temperature (25° C.) were measured in an EHD contact using a viscometer (with a 3°×R9.7 cone rotor, manufactured by Toki Sangyo Co., Ltd.) at 10 rpm. A rate of change in viscosity relative to the viscosity immediately after being prepared, which was set as 1.0, was then calculated as a rate of viscosity increase. A higher rate of viscosity increase indicates that the viscosity of the adhesive composition increased with the lapse of time. Thus, it can be said that the composition is approaching a state where it cannot be used as an adhesive. Conversely, a lower rate of viscosity increase indicates that no change in viscosity occurred over time. Thus, it can be said that the composition is still in a state where it can be used as an adhesive. In other words, when the rate of viscosity increase is low, it can be said that the pot life is long. Examples and Comparative Examples with a rate of viscosity increase of 1.5 or lower were indicated by white circle (∘) signs and those with a tate of viscosity increase of higher than 1.5 were indicated by cross (×) signs.

### Partial Curing

Each adhesive composition was dispensed onto a copper substrate (having a thickness of 0.15 mm) and a square alumina chip that is 5 mm on a side was bonded thereto. Subsequently, the copper substrate was contacted to a hot plate and heated at 120° C. for 1 second. Bond strength under compression shear stress was then measured using a Nordson Dage Series 4000 Multipurpose Bond Tester. Examples and Comparative Examples with a bond strength of equal to or higher than 0.1 kgf/mm² were indicated by white circle (∘) signs and those with a bond strength of lower than 0.1 kgf/mm² were indicated by cross (x) signs.

### Complete Curing

Specimens obtained by performing partial curing according to the same method as above were heated at 80° C. for 30 minutes in a convection oven. Bond strength under compression shear stress was then measured using a Nordson Dage Series 4000 Multipurpose Bond Tester. Examples and Comparative Examples with a bond strength that was equal to or higher than 0.5 kgf/mm² and a factor of two or more higher than the value obtained after the partial curing, were indicated by white circle (∘) signs, and those with a bond strength that was lower than 0.5 kgf/mm² or less than a factor of two of the value obtained after the partial curing were indicated by cross (x) signs. The reason for this lies in the fact that, when the value of the bond strength after complete curing is smaller than a factor of two of the value after partial curing, curing has already proceeded to a substantial degree at the point of partial curing. Accordingly, the use of the two-stage process involving partial curing and complete curing becomes less advantageous.

TABLE 1

| | | Example 1 | Example 2 | Example 3 | Example 4 | Example 5 | Example 6 | Example 7 |
|---|---|---|---|---|---|---|---|---|
| | | (Adhesive | (Adhesive | (Adhesive | (Adhesive | (Adhesive | (Adhesive | (Adhesive |
| | | composition a) | composition b) | composition c) | composition d) | composition e) | composition f) | composition g) |
| Curable | BMI-1500 | 7 | 7 | 7 | 7 | 7 | 5.6 | 8.4 |
| resin | BMI-3000 | | | | | | | |
| | Light Acrylate | 7 | 7 | 7 | 7 | 7 | 8.4 | 5.6 |
| | PO-A | | | | | | | |
| Radical | Peroyl TCP | 1.35 | 1.2 | 1.5 | 1.2 | 1.5 | 1.35 | 1.35 |
| polymer- | PEROCTAO | | | | | | | |
| ization | | | | | | | | |
| initiator | | | | | | | | |
| Radical | Q-1301 | 0.014 | 0.012 | 0.016 | 0.016 | 0.012 | 0.014 | 0.014 |
| polymer- | Hydroquinone | | | | | | | |
| ization | TEMPO | | | | | | | |
| inhibitor | | | | | | | | |
| Others | Silver filler | 86 | 86 | 86 | 86 | 86 | 86 | 86 |
| Evaluation | Percent increase | ◯ | ◯ | ◯ | ◯ | ◯ | ◯ | ◯ |
| Results | in viscosity | | | | | | | |
| | Partial curing | ◯ | ◯ | ◯ | ◯ | ◯ | ◯ | ◯ |
| | Complete curing | ◯ | ◯ | ◯ | ◯ | ◯ | ◯ | ◯ |

| Comparative | Comparative | Comparative | Comparative | Comparative | Comparative |
|---|---|---|---|---|---|
| Example 1 | Example 2 | Example 3 | Example 4 | Example 5 | Example 6 |
| (Adhesive | (Adhesive | (Adhesive | (Adhesive | (Adhesive | (Adhesive |
| composition h) | composition i) | composition j) | composition k) | composition l) | composition m) |
| 7 | 7 | 7 | 7 | 7 | |
| | | | | | 28 |
| 7 | 7 | 7 | 7 | 7 | 7 |
| | 1.35 | 1.35 | 0.9 | 1.35 | 1.35 |
| 1.35 | | | | | |
| 0.014 | | | 0.014 | 0.025 | 0.014 |
| | 0.014 | | | | |
| | | 0.014 | | | |
| 86 | 86 | 86 | 86 | 86 | 86 |
| ◯ | ◯ | X | ◯ | ◯ | ◯ |
| X | X | X | X | X | ◯ |
| X | X | ◯ | ◯ | ◯ | X |

As shown in Table 1, the adhesive compositions in the Examples had a sufficient rate of viscosity increase even after an elapse of 48 hours at room temperature. In other words, it was found that the adhesive compositions in the Examples have a long pot life.

In addition, the adhesive compositions in the Examples exhibited reliable adhesion via the partial curing at the high temperature and the subsequent complete curing at the lower temperature. In contrast, the adhesive compositions in the Comparative Examples were only insufficiently partial-cured at the high temperature. In the Comparative Example 1, the bond strengths after the partial curing and the complete curing were low because the organic peroxide having a one-minute half-life temperature of higher than 100° C. was used. In the Comparative Example 2, the bond strengths after the partial curing and the complete curing were low because hydroquinone was used as the radical polymerization inhibitor. In the Comparative Example 3, the partial curing could not be performed even though the composition had curability at low temperatures. In the Comparative Example 4 in which the amount of organic peroxide was too small and the Comparative Example 5 in which the amount of radical polymerization inhibitor was too large, the partial curing could not be performed even though the compositions had curability at low temperatures. In the Comparative Example 6, the bond strength after the partial curing was low because voids were generated. In conclusion, it was found that the adhesive compositions in the Comparative Examples were inappropriate for cases where high positional accuracy is required.

Furthermore, according to the results of the Examples 1 to 7 and the Comparative Example 1, it was found that partial curing at high temperatures and complete curing at low temperatures are difficult with radical polymerization initiators having a one-minute half-life temperature of higher than 120° C. whereas those having a one-minute half-life temperature of lower than 100° C. are suitable for partial curing at high temperatures and complete curing for low temperatures.

From the aforementioned results, it was also found that the adhesive compositions in the Examples 1 to 7 have a longer pot life than those in the Comparative Examples 1 to 6 and can be cured completely at a temperature lower than that for partial curing.

While the embodiments and Examples of the present invention have been described, they are provided only for the illustrative purpose and are not intended to limit the scope of the invention. The embodiments can be implemented in different modes, and various omissions, substitutions, or modifications can be made without departing from the subject matter of the invention. These embodiments and their variations are encompassed in the scope and spirit of the invention as well as in the inventions recited in claims and their equivalences.

1. An adhesive composition comprising:
a curable resin that is radically polymerizable;
an organic peroxide having a one-minute half-life temperature of less than 100° C.; and
a radical polymerization inhibitor, wherein
a rate of viscosity increase of the adhesive composition at 25° C. and after 48 hours is 1.5 or less, a partial curing of the adhesive composition is possible by heating at 100° C. to 180° C. for 1 to 5 second(s), and a complete curing of the adhesive composition is possible by heating at 70° C. to 100° C. after the partial curing.

2. The adhesive composition according to claim 1, wherein a heating condition for the partial curing is 120° C. and 3 seconds or less and a heating condition for the complete curing is 80° C.

3. The adhesive composition according to claim 1, wherein the radical polymerization inhibitor is a nitrosamine compound.

4. The adhesive composition according to claim 1, wherein the organic peroxide is any one of peroxybis(formic acid propyl) ester, peroxybis(formic acid isopropyl) ester, bis(4-tert-butylcyclohexyl) peroxydicarbonate, 1,1,3,3-tetramethylbutyl peroxyneodecanoate, peroxybis(formic acid sec-butyl) ester or a combination thereof.

5. The adhesive composition according to claim 1, wherein the curable resin comprises 40% to 60% by weight of a curable resin contributing to radical polymerization and having a functional group equivalent weight of 600 to 900.

6. An adhesive composition comprising:
a curable resin comprising 40% to 60% by weight of a curable resin contributing to radical polymerization and having a functional group equivalent weight of 600 to 900;
any one of peroxybis(formic acid propyl) ester, peroxybis(formic acid isopropyl) ester, bis(4-tert-butylcyclohexyl) peroxydicarbonate, 1,1,3,3-tetramethylbutyl peroxyneodecanoate, peroxybis(formic acid sec-butyl) ester; and
a nitrosamine compound.

7. The adhesive composition according to claim 1, further comprising a precious metal filler.

8. A cured product obtained by curing the adhesive composition according to claim 1.

9. A precision part with the cured product according to claim 8.

10. The adhesive composition according to claim 6, further comprising a precious metal filler.

11. A cured product obtained by curing the adhesive composition according to claim 6.
